(19) United States
(12) Patent Application Publication
(10) Pub. No.: US 2021/0113946 A1
(43) Pub. Date: Apr. 22, 2021

(54) ROTATING FILTERS AND RELATED SYSTEMS

(71) Applicant: HãF Equipment LLC, Maplewood, MN (US)

(72) Inventor: Peter Hoefler, Dellwood, MN (US)

(21) Appl. No.: 17/133,542

(22) Filed: Dec. 23, 2020

Related U.S. Application Data
(63) Continuation of application No. PCT/US2019/039000, filed on Jun. 25, 2019.
(60) Provisional application No. 62/689,711, filed on Jun. 25, 2018.

(51) Int. Cl. B01D 33/073; B01D 33/067; B01D 46/26; B01D 46/00

(52) U.S. Cl. CPC B01D 33/073; B01D 33/067; B01D 2201/287; B01D 46/0045; B01D 46/0056; B01D 46/26

(57) ABSTRACT

In accordance with an aspect of the present disclosure, an apparatus includes a tubular filter and a motor coupled to the tubular filter. The tubular filter includes a plurality of apertures. The motor rotates the tubular filter about an axis while a differential pressure is applied to an interior space of the tubular filter relative to exterior to the tubular filter. A force is applied, related to the rotation of the tubular filter, to particulate matter agglomerated to an exterior surface of the tubular filter such that the particulate matter is removed from the exterior surface.

### CROSS-REFERENCE TO RELATED APPLICATIONS

The present application claims the benefit of priority and is a continuation of International Patent Application No. PCT/US2019/039000, filed Jun. 25, 2019, which in turn claims the benefit of priority to U.S. Provisional Patent Application No. 62/689,711, filed Jun. 25, 2018. The contents of each of the aforementioned patent applications is incorporated by reference herein in its entirety for any purpose whatsoever.

### BACKGROUND

Filters may be use to separate particulate matter from fluid. In the course of operation, particulate matter may adhere to the exterior surface of a filter and/or partially or fully block apertures of the filter. Some previous approaches to removing agglomerated particulate matter from the exterior surface of a filter include a structure or component that physically contacts the exterior surface as the filter rotates to pry and/or force the particulate matter off. Such previous approaches require structures that can break down and require cleaning themselves. Some previous approaches cannot clean a filter while filtering a fluid.

### SUMMARY

Aspects of the present disclosure relate to, among other things, rotating filters that may be tubular. Each of the aspects disclosed herein may include one or more of the features described in connection with any of the other disclosed aspects.

In accordance with the disclosure, embodiments of an apparatus are provided. Certain of such embodiments include a tubular filter including a plurality of apertures; and a motor coupled to the tubular filter. The motor is configured and arranged to rotate the tubular filter about an axis while a differential pressure is applied to an interior space of the tubular filter relative to exterior the tubular filter. If desired, the apparatus can be configured to apply a force, such as one related to the rotation of the tubular filter, to particulate matter agglomerated to an exterior surface of the tubular filter such that the particulate matter is removed from the exterior surface of the tubular filter.

In some implementations the apparatus can further include a pump configured and arranged to draw a fluid through the apertures of the tubular filter from the interior space of the tubular filter while the tubular filter rotates. If desired, the apparatus can further include a pump configured and arranged to force a fluid through the apertures of the tubular filter from exterior the tubular filter while the tubular filter rotates.

In some implementations, the tubular filter can include one or more vanes coupled to the exterior surface of the tubular filter. The one or more vanes can be configured and arranged to guide the fluid through the apertures. For example, the entrance(s) of the vane(s) can be arranged in an orientation of the rotation of the tubular filter. The entrance(s) of the vane(s) can be arranged in an orientation opposite to the rotation of the tubular filter.

If desired, the tubular filter can include one or more impeller(s) coupled to the tubular filter, such as to an inner surface of the tubular filter. The at least one impeller can be configured and arranged to draw the fluid through the apertures of the tubular filter from the interior space of the tubular filter as the tubular filter rotates. If desired, the tubular filter can have a circular, elliptical, or polygonal (e.g., triangular, rectangular, pentagonal, hexagonal, octagonal, and the like) cross section.

In accordance with further aspects, the apparatus can further include a vessel configured and arranged to contain the removed particulate matter. The vessel can be a portion of a flow system, for example, such as a housing that transitions into a chute in a lower portion thereof to guide and/or contain the removed particulate matter.

In further accordance with the disclosure, an apparatus is provided that includes a tubular filter that in turn defines a plurality of apertures therethrough. The tubular filter can be positioned substantially horizontally or vertically in a chamber, or may be disposed at an angle between horizontal and vertical in any increment of one degree. The system further includes a first pump coupled to the chamber. The first pump is configured to draw an unfiltered fluid flow into the chamber. The system can further include a second pump coupled to the tubular filter. The second pump can be configured to draw a filtered fluid flow from an interior space of the tubular filter. The filtered fluid can include the unfiltered fluid drawn through the apertures of the tubular filter.

In further accordance with the disclosure, the apparatus can further include a motor coupled to the tubular filter. The motor can be configured to rotate the tubular filter about an axis while a differential pressure is applied to an interior space of the tubular filter relative to exterior the tubular filter. If desired, the apparatus can be configured to apply a force (such as a force that is attributable in part to the rotation of the tubular filter) to particulate matter agglomerated to an exterior surface of the tubular filter such that the particulate matter is removed from the exterior surface.

In some implementations, the tubular filter can include one or more vanes coupled to the exterior surface of the tubular filter. The one or more vanes can be configured to guide the unfiltered fluid through the apertures. For example, the entrance(s) of the vane(s) can be arranged in an orientation of a rotation of the tubular filter. Alternatively, the entrance(s) of the vane(s) can be arranged in an orientation opposite to a rotation of the tubular filter.

In some embodiments, the tubular filter can include an impeller coupled to an inner surface of the tubular filter. The impeller can be configured to draw the unfiltered fluid through the apertures of the tubular filter from the interior space of the tubular filter as the tubular filter rotates. The tubular filter can have a cross section of any desired shape, such as a circle, ellipse, polygon, or a perimeter that follows an undulating sinusoidal path.

It may be understood that both the foregoing general description and the following detailed description are exemplary and explanatory only and are not restrictive of the features claimed.

As used herein, the terms “comprises,” “comprising,” or any other variation thereof, are intended to cover a non-exclusive inclusion such that a process, method, article, or apparatus that comprises a list of elements does not necessarily include only those elements, but may include other elements not expressly listed or inherent to such process, method, article, or apparatus. The term “exemplary” is used in the sense of “example,” rather than “ideal.”

### BRIEF DESCRIPTION OF THE DRAWINGS

The accompanying drawings, which are incorporated in and constitute a part of this specification, illustrate exemplary aspects of the present disclosure and together with the description, serve to explain the principles of the disclosure.

FIG. 1 is a perspective view of a tubular filter cleaning system, in accordance with aspects of the present disclosure;

FIG. 2 is a block diagram of a filtration system including a tubular filter cleaning system, in accordance with aspects of the present disclosure;

FIGS. 3A-3D show exemplary cross-sectional profiles of tubular filters, in accordance with aspects of the present disclosure;

FIG. 4A is a cross-section view of a tubular filter having a plurality of vanes oriented in the direction of rotation of the tubular filter, in accordance with aspects of the present disclosure;

FIG. 4B is a cross-section view of a tubular filter having a plurality of vanes oriented oppositely to the direction of rotation of the tubular filter, in accordance with aspects of the present disclosure;

FIG. 5A shows a filtration system including a tubular filter cleaning system, in accordance with aspects of the present disclosure;

FIG. 5B shows a chamber of the filtration system of FIG. 5A; and

FIG. 6 is a block diagram of the filtration system of FIG. 5A.

### DETAILED DESCRIPTION

The present disclosure is drawn, in various implementations, to rotating tubular filters and related methods. Reference now will be made in detail to aspects of the present disclosure, examples of which are illustrated in the accompanying drawings. Wherever possible, the same reference numbers will be used throughout the drawings to refer to the same or like parts. The term “distal” refers to a portion farthest away from a user when introducing a device into a subject. By contrast, the term “proximal” refers to a portion closest to the user when placing the device into the subject. The term “approximately,” when used to describe a numerical value, may be anywhere in a range of ±5% from the numerical value.

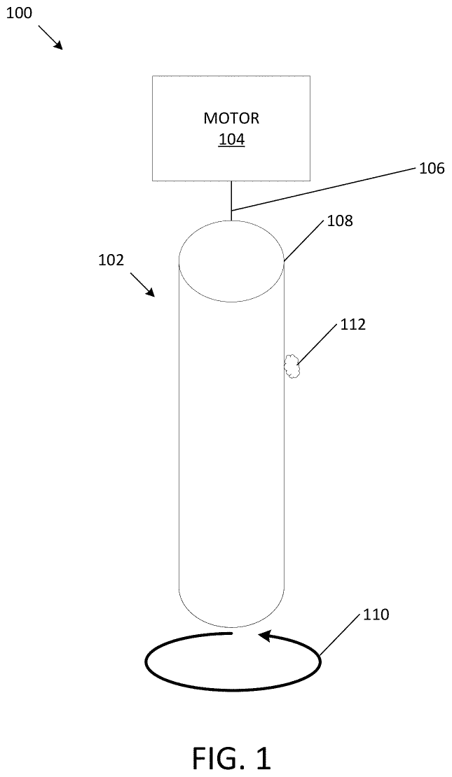

FIG. 1 is a perspective view of a tubular filter cleaning system 100, in accordance with aspects of the present disclosure. The system 100 includes a tubular filter 102. The tubular filter 102 has a plurality of apertures (not shown). The tubular filter 102 can be porous. The apertures can vary in size and/or quantity based on the application. The size of the apertures can be dependent on the size of the particulate matter to be filtered from the fluid flow. The tubular filter 102 is coupled to a motor 104 configured and arranged to rotate the tubular filter 102 about an axis that is substantially parallel to the longitudinal axis of the tubular filter 102. For example, the axis of rotation can coincide with the longitudinal axis of the tubular filter 102 or the axis of rotation can be offset from the longitudinal axis of the tubular filter 102.

FIG. 1 shows the tubular filter 102 coupled to the motor 104 via the line 106. The line 106 represents a mechanical drive between the motor 104 and the tubular filter 102. The filter includes a freely floating end and a secured end. The secured end is typically attached to a drive bracket that is rotationally disposed on a bearing to permit the filter to rotate. Non-limiting examples of the drive can include an electric motor with a belt drive, gear drive, or the like. The motor can also be directly coupled to the filter via a drive shaft, and the like.

The arrow 110 indicates the direction of rotation of the tubular filter 102. Although the arrow 110 indicates the tubular filter rotating in a counterclockwise direction, implementations in accordance with the present disclosure are not so limited. In at least one implementation, the motor 104 changes the direction of the rotation. The motor 104 can quickly and/or abruptly alternate the direction of rotation so as to provide a shaking motion in addition to the rotation.

In at least one implementation, the rate of rotation of the tubular filter 102 is variable. Centripetal force, generated from the rotation of the tubular filter 102, is used to remove agglomerated particulate matter 112 from the exterior surface of the tubular filter 102. The centripetal force applied to the agglomerated particulate matter 112 is directly proportionate to the tangential velocity of the exterior surface of the tubular filter 102, which is directly proportionate to the angular velocity (the rate of rotation) of the tubular filter 102. Thus, the rate of rotation can be increased to increase the centripetal force applied to the agglomerated particulate matter 112. Depending on the size of the agglomerated particulate matter and/or the mechanism of agglomeration (e.g., moisture, electrostatic force, Van der Walls forces, friction) of the agglomerated particulate matter to the tubular filter 102, a greater amount of force may be required to remove the agglomerated particulate matter. Once agglomerated particles have formed of a large enough size, they become more susceptible to dislodgement due to having a larger inertia. The dislodged particles can then fall downward into a collection system where they are collected. The filter can be rotated at any desired velocity, such as between 100 RPM and 15,000 RPM, or any value therebetween in increments of 1.0 RPM. For example, the speed can be provided in the range of 100-300 RPM, 500-8000, RPM, or any sub-range of 10, 25, 50, or 100 RPM in the range of about 100 to 15,000 RPM, inclusive of the endpoints of said range.

Some previous approaches have a limited rate of rotation of a filter because the physical component or structure that contacts the filter and/or the filter may be limited if the force of contact between the physical component or structure and the filter is too strong. Thus, previous approaches rotate filters at a slow rate to reduce the contact force. In contrast, implementations in accordance with the present disclosure do not require physical contact of the exterior surface of the tubular filter 102 with another component and/or structure. Thus, the tubular filter 102 can rotate at much higher rates than previous approaches, thereby enabling the tubular filter 102 to be cleaned in a faster and/or more efficient manner.

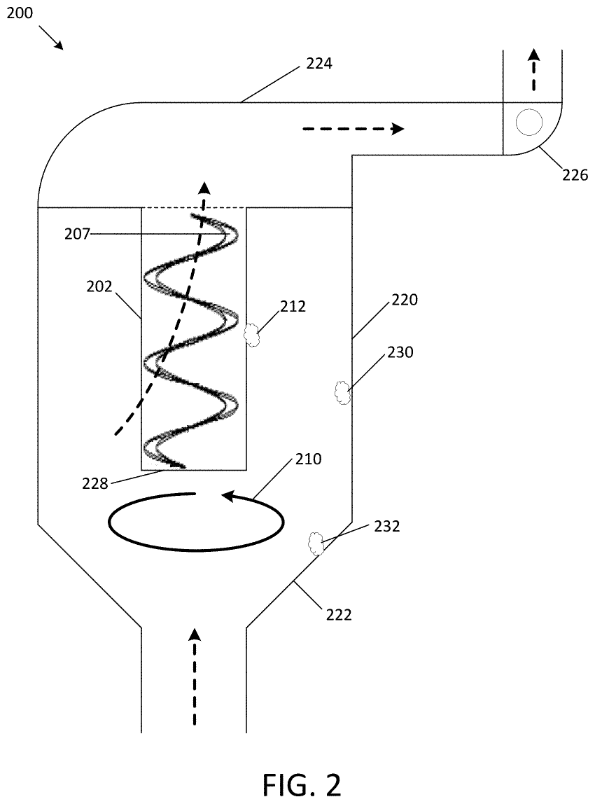

As described below in association with FIG. 2, the tubular filter 102 can be cleaned (e.g., rotated) while removing particulate matter from a fluid flow. A prior art filter may get clogged and remained clogged until the filtration process is stopped and the filter is cleaned. In contrast, if an aperture of the tubular filter 102 is clogged by agglomerated particulate matter, it is clogged only momentarily because of the force applied to the agglomerated particulate matter as a result of the rotation of the tubular filter 102. In some instances, the force applied to the agglomerated particulate matter as a result of the rotation of the tubular filter 102 prevents the agglomerated particulate matter from even being able to clog an aperture before the agglomerated particulate matter is removed from the tubular filter 102. Thus, the tubular filter 102 can maintain a level of performance throughout the filtration process.

FIG. 2 is a block diagram of a filtration system 200 including a tubular filter cleaning system, in accordance with aspects of the present disclosure. The tubular filter 202 can be analogous to the tubular filter 102 illustrated in FIG. 1. The tubular filter 202 is coupled to a motor (not shown) that is configured and arranged to rotate the tubular filter 202. For example, the tubular filter 202 can rotate in the direction indicated by the arrow 210. The system 200 includes a pump, for example, fan 226, that is configured and arranged to apply a differential pressure to an interior space of the tubular filter 202 relative to exterior the tubular filter 202. For example, the fan 226 can be located downstream of the filter 202 and draw a fluid (e.g., air) into the tubular filter 202. Or, the fan 226 can force a fluid through the tubular filter 202 from exterior the tubular filter 202. The dashed arrows indicate an exemplary direction of the fluid flow. In FIG. 2, the fluid flow, including particulate matter, begins in funnel 222 and passes through the tubular filter 202. The filtered fluid flow enters the duct 224 from the interior of the tubular filter 202, as indicated by the dashed line, before reaching the fan 226 and exiting the system 200. In at least one implementation, the fan 226 can be positioned at or near the entrance to the system 200. Another fan, in addition to the fan 226, can be positioned at or near the entrance to the system 200. In at least one implementation, the end 228 of the tubular filter 202 can include apertures such that the end 228 can filter particulate matter from the fluid flow.

To remove agglomerated particulate matter, such as particulate matter 212, from the exterior surface of the tubular filter 202, the tubular filter 202 rotates to apply a force (e.g., centripetal force) to the particulate matter 212. The force is sufficient to overcome whatever force is adhering the particulate matter 212 to the tubular filter 202. After removing the particulate matter 212 from the tubular filter 202, wall 220 of a vessel of the system 200 contains the removed particulate matter, as illustrated by particulate matter 230. The vessel includes the tubular filter 202 and the funnel 222, and can be cylindrical. Particulate matter contained by the wall 220 can fall to the funnel 222. The funnel 222 can direct particulate matter, such as particulate matter 232, to a collection point. For example, the collection point can be a chamber or a container positioned below the funnel 222.

The tubular filter 202 can rotate during operation of the system 200 (e.g., when a fluid flow is being filtered). As a result, the system 200 can yield energy and/or cost savings and/or increased efficiency by enabling cleaning of the tubular filter 202 during operation of the system 200 without having to stop filtering the fluid.

The tubular filter 202 can rotate during a cleaning mode, separate from operation of the system 200. For example, the tubular filter 202 can rotate at a first rate or a first range of rates during operation and a second rate or a second range of rates in a cleaning mode. The second rate or range of rates can be faster than the first rate or range of rates. Thus, a cleaning mode in which the tubular filter 202 is rotated faster can be used to remove additional agglomerated particulate matter on the tubular filter 202 and/or agglomerated particulate matter that requires a stronger force to overcome the force that is adhering the agglomerated particulate matter to the tubular filter 202. During a cleaning mode, or during any other selected time, pressure can be reversed, such as by pulsing, to cause flow to momentarily reverse through the filter 202. Additionally or alternatively, an external fluid jet (gas or liquid) can be pulsed at the filter to assist in cleaning, if desired.

In at least one implementation, the tubular filter 202 can include at least one impeller positioned in the interior space of the tubular filter 202. The impeller can be coupled to the inner surface of the tubular filter 202. Because the tubular filter 202 can rotate during operation of the system 200, the impeller can replace or supplement the fan 226 so that the energy used to rotate the tubular filter 202 can also provide suction of the fluid through the tubular filter 202. As a result, the system 200 can yield energy and/or cost savings by reducing the size of the fan 226 or eliminating the fan 226. The impeller(s) can have any suitable geometry including having one or more vanes that are oriented approximately perpendicular to the length of the filter. If desired, the filter 202 can slide over an impeller assembly that is affixed to a rotational bearing that is attached to a motor or transmission. In one embodiment, the impeller can be a helical vane 207 (FIG. 2) attached to an inwardly facing surface of filter 202 that may define an empty flow channel along its center. Alternatively, such a vane can be part of a structure that the filter 202 fits over and that drives rotation of the filter 202.

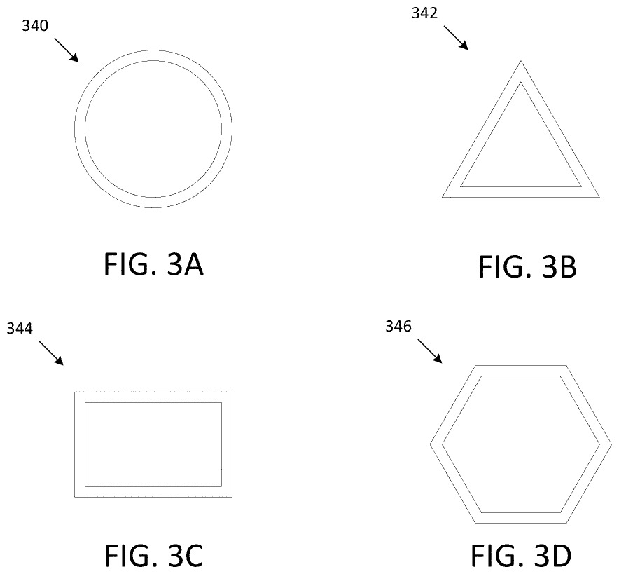

FIGS. 3A-3D show exemplary cross-sectional profiles of tubular filters 340, 342, 344, and 346, in accordance with aspects of the present disclosure. Tubular filter 340 has a substantially circular cross-section. Tubular filter 342 has a triangular cross-section. Tubular filter 344 has a rectangular cross-section. Tubular filter 346 has a hexagonal cross-section. Any of the tubular filters 340, 342, 344, or 346 can be analogous to the tubular filter 102 illustrated in FIG. 1. Although the tubular filters 340, 342, 344, or 346 are shown having a smooth exterior surface, implementations are not so limited. For example, the tubular filters 340, 342, 344, or 346 can have a corrugated exterior surface. FIGS. 3A-3D do not convey any thickness of the walls of the tubular filters 340, 342, 344, or 346, or any other dimensions.

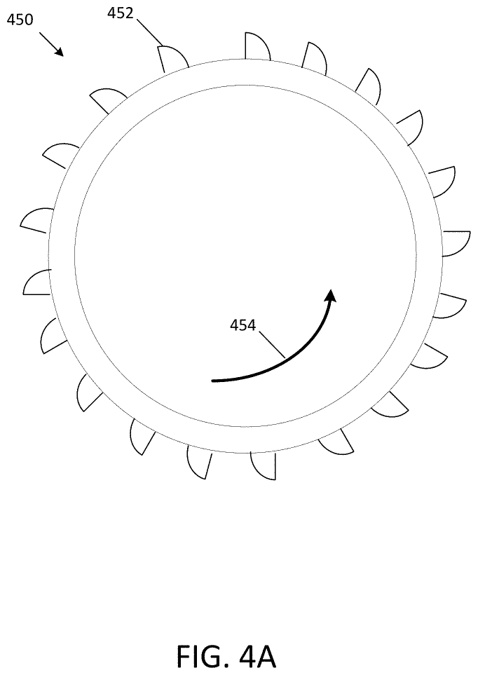

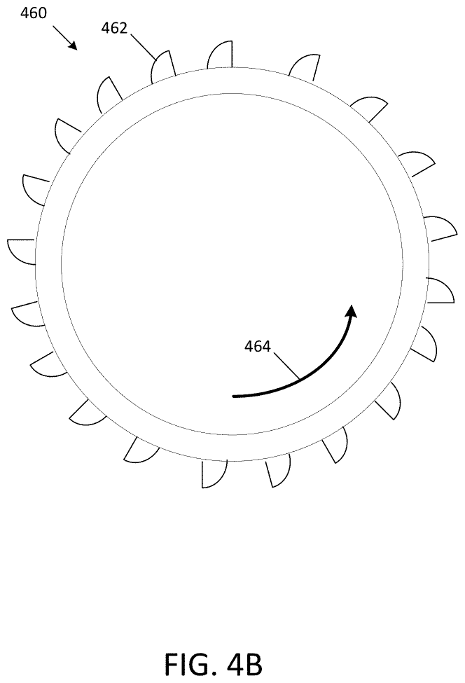

FIG. 4A is a cross-section view of a tubular filter 450 having a plurality of vanes oriented in the direction of rotation of the tubular filter, in accordance with aspects of the present disclosure. The tubular filter 450 can be analogous to the tubular filter 102 illustrated in FIG. 1. The arrow 454 indicates the direction of rotation of the tubular filter 450. The plurality of vanes include the vane 452, for example. Although FIG. 4A shows twenty vanes, implementations are not so limited. The vanes can be evenly spaced from one another, follow a pattern of spacing, or be randomly spaced from one another. The vanes can be in a ring around the circumference of the tubular filter 450. The vanes can be in a spiral around the circumference and along the length of the tubular filter 450. FIG. 4A does not convey any thickness of the walls of the tubular filter 450, the size of the vanes, or any other dimensions. The vanes can help direct the fluid flow through the tubular filter 450, and/or help prevent deposition on the filter's surface.

FIG. 4B is a cross-section view of a tubular filter 460 having a plurality of vanes oriented oppositely to the direction of rotation of the tubular filter 460, in accordance with aspects of the present disclosure. The tubular filter 460 can be analogous to the tubular filter 102 illustrated in FIG. 1. The arrow 464 indicates the direction of rotation of the tubular filter 460. The plurality of vanes include the vane 462, for example. Although FIG. 4B shows twenty vanes, implementations are not so limited. The vanes can be evenly spaced from one another, follow a pattern of spacing, or be randomly spaced from one another. The vanes can be in a ring around the circumference of the tubular filter 460. The vanes can be in a spiral around the circumference and along the length of the tubular filter 460. FIG. 4B does not convey any thickness of the walls of the tubular filter 460, the size of the vanes, or any other dimensions. Because the vanes are oriented oppositely to the direction of rotation of the tubular filter 460, the vanes help direct the fluid flow through the tubular filter 460 by “scooping” the fluid.

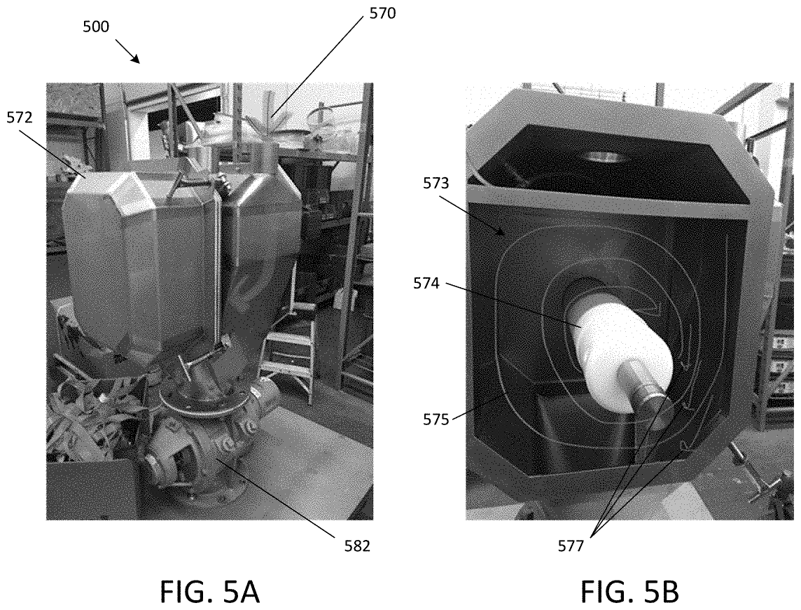

FIG. 5A shows a filtration system 500 including a tubular filter cleaning system, in accordance with aspects of the present disclosure. In contrast to the filtration system 200 shown in FIG. 2, the unfiltered fluid flow enters the filtration system 500 from the top of the filtration system 500 as indicated by the arrow 570. FIG. 5B shows a chamber 573 of the filtration system 500. In FIG. 5B, the cover 572 shown in FIG. 5A has been removed from the system 500 so that the tubular filter 574 is now visible. As shown in FIG. 5B, the tubular filter 574 is positioned substantially horizontally within the chamber 573 (in contrast to the tubular filter 202 shown in FIG. 2) so that the tubular filter 574 is substantially orthogonal to the unfiltered fluid flow (as indicated by the arrow 575). Positioning the tubular filter 574 horizontally can impart a helicity to unfiltered fluid flow depending on flow conditions. During relatively lower rotational speeds, the filter will largely draw flow in radially inwardly toward the filter (e.g., 202, 574). If a helical flow pattern is developed, the relatively rapid change in momentum may also cause some particulate to become un-entrained in the flow, and fall downward to be collected at the bottom of the system. Rotation of the filter, however, will cause a significant amount of fluid shear at and near the surface of the rotating filter element, which will help to strip agglomerated material from the filter. The system 500 includes a fan (not shown) configured to draw the fluid through the interior space of the tubular filter 574. The unfiltered fluid is pulled through apertures of the tubular filter 574 and into the interior space of the tubular filter 574. As particulate are de-entrained from the fluid flow, and as agglomerated particulate are removed from the rotating filter (e.g., 202, 574) the particulate matter generally falls downwardly as indicated by the arrows 576.

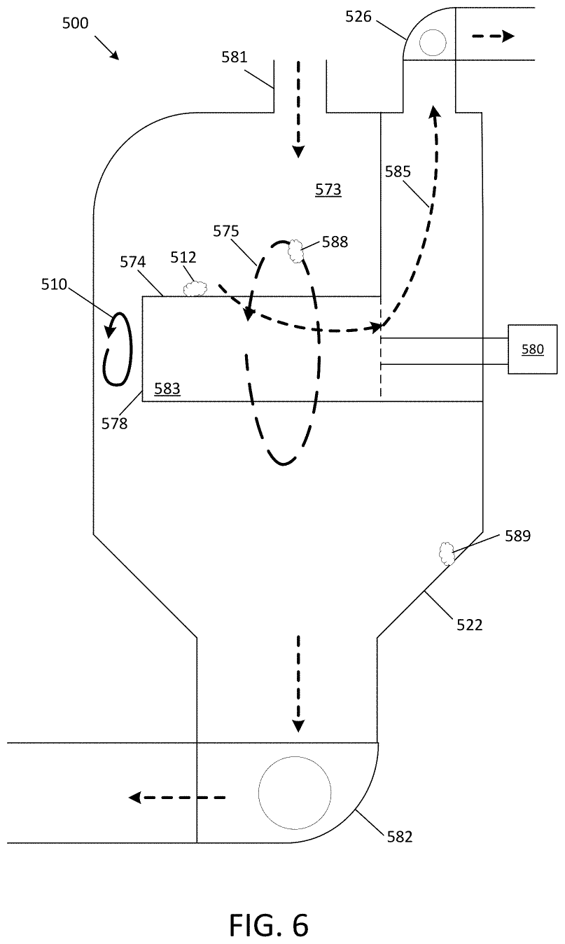

In FIG. 6, an unfiltered fluid flow, including particulate matter, begins in a duct 581. The system 500 includes another pump 526 (e.g., fan) configured to apply a negative pressure differential from the chamber 573 and the interior space 583 so that the unfiltered fluid flow is drawn through apertures of the tubular filter 574 and into the interior space 583 of the tubular filter 574 before reaching the pump 526 and exiting the system 500 as indicated by the dashed arrow 585. The pump 526 can apply a greater negative pressure differential than the pump 582 so that the unfiltered flow is directed through the tubular filter 574. If desired, pump 582 can alternatively be omitted, and the bottom of the system can be used to collect and remove particulate matter that is removed from the gas stream. Moreover, a valve or rotary air lock can be used in addition to or instead of pump 582 to allow the collected particles to exit the system.

In at least one implementation, the tubular filter 574 is coupled to a motor 580 that is configured and arranged to rotate the tubular filter 574. For example, the tubular filter 574 can rotate in the direction indicated by the arrow 510. To remove agglomerated particulate matter, such as particulate matter 512, from the exterior surface of the tubular filter 574, the tubular filter 574 rotates to apply a force (e.g., centripetal force) to the particulate matter 512. The force is sufficient to overcome whatever force is adhering the particulate matter 512 to the tubular filter 574. After removing the particulate matter 512 from the tubular filter 574, the particulate matter can be caught in the swirling fluid flow as illustrated by the particulate matter 588. As explained above in association with FIGS. 5A and 5B, the particulate matter 588 escapes the swirling fluid flow and can fall to the funnel 522. The funnel 522 can direct particulate matter, such as particulate matter 589, to a collection point. For example, the collection point can be a chamber or a container positioned below the funnel 522.

The tubular filter 574 can rotate during operation of the system 500 (e.g., when a fluid flow is being filtered). As a result, the system 500 can yield energy and/or cost savings and/or increased efficiency by enabling cleaning of the tubular filter 574 during operation of the system 500 without having to stop filtering the fluid.

The tubular filter 574 can rotate during a cleaning mode, separate from operation of the system 500. For example, the tubular filter 574 can rotate at a first rate or a first range of rates during operation and a second rate or a second range of rates in a cleaning mode. The second rate or range of rates can be faster than the first rate or range of rates. Although the tubular filter 574 can rotate during operation of the system 500, rotating at too fast of a rate may interfere with the ability of the tubular filter 574 to remove particulate matter from the fluid flow. Thus, a cleaning mode in which the tubular filter 574 is rotated faster can be used to remove additional agglomerated particulate matter on the tubular filter 574 and/or agglomerated particulate matter that requires a stronger force to overcome the force that is adhering the agglomerated particulate matter to the tubular filter 574. The system can also be provided with fluid jets and be configured to pulse the flow in a reverse direction to remove particulate, if desired.

In at least one implementation, the tubular filter 574 can include an impeller positioned in the interior space 583 as described elsewhere herein. The impeller can be coupled to the inner surface of the tubular filter 574. In such an implementation, the end 578 is at least partially open to facilitate flow into and through the tubular filter 574. The opposite end of the tubular filter 578 includes apertures so that the unfiltered fluid pulled into the interior space 583 from the end 578 is filtered. Because the tubular filter 574 can rotate during operation of the system 200, the impeller can replace or supplement the fan 526 so that the energy used to rotate the tubular filter 574 can also provide suction of the fluid through the tubular filter 574. As a result, the system 500 can yield energy and/or cost savings by reducing the size of the fan 526 or eliminating the fan 526.

The filter 202 and other filters herein can be made from any suitable material, such as a porous polymeric tubular member, a porous metallic tubular member, or a porous composite material, for example. The size and distribution of the pores can be varied, as desired, to suit different flow conditions.

It will be apparent to those skilled in the art that various modifications and variations can be made in the disclosed devices and methods without departing from the scope of the disclosure. Other aspects of the disclosure will be apparent to those skilled in the art from consideration of the specification and practice of the features disclosed herein. It is intended that the specification and examples be considered as exemplary only.

What is claimed is:

1. An apparatus, comprising:
a tubular filter including a plurality of apertures; and
a motor coupled to the tubular filter, wherein the motor is configured and arranged to rotate the tubular filter about an axis while a differential pressure is applied to an interior space of the tubular filter relative to exterior the tubular filter, and further wherein the apparatus is configured to apply a force to particulate matter agglomerated to an exterior surface of the tubular filter such that the particulate matter is removed from the exterior surface.

2. The apparatus of claim 1, further comprising a pump configured and arranged to draw a fluid through the apertures of the tubular filter from the interior space of the tubular filter while the tubular filter rotates.

3. The apparatus of claim 1, further comprising a pump configured and arranged to force a fluid through the apertures of the tubular filter from exterior the tubular filter while the tubular filter rotates.

4. The apparatus of claim 1, wherein the tubular filter includes a plurality of vanes coupled to the exterior surface and configured and arranged to guide the fluid through the apertures.

5. The apparatus of claim 4, wherein entrances of the vanes are arranged in an orientation of the rotation of the tubular filter.

6. The apparatus of claim 4, wherein entrances of the vanes are arranged in an orientation opposite to the rotation of the tubular filter.

7. The apparatus of claim 1, wherein the tubular filter includes at least one impeller coupled to an inner surface of the tubular filter, wherein the at least one impeller is configured and arranged to draw the fluid through the apertures of the tubular filter from the interior space of the tubular filter as the tubular filter rotates.

8. The apparatus of claim 1, wherein the tubular filter has a circular cross section.

9. The apparatus of claim 1, wherein the tubular filter has a rectangular cross section.

10. The apparatus of claim 1, wherein the tubular filter has a triangular cross section.

11. The apparatus of claim 1, wherein the tubular filter has a hexagonal cross section.

12. The apparatus of claim 1, further comprising a vessel configured and arranged to contain the removed particulate matter.

13. An apparatus, comprising:
a tubular filter including a plurality of apertures, the tubular filter being positioned substantially horizontal in a chamber;
a first pump coupled to the chamber and configured to draw an unfiltered fluid flow into the chamber; and
a second pump coupled to the tubular filter and configured to draw a filtered fluid flow from an interior space of the tubular filter, wherein the filtered fluid is the unfiltered fluid drawn through the apertures of the tubular filter.

14. The apparatus of claim 13, further comprising:
a motor coupled to the tubular filter, wherein:
the motor is configured to rotate the tubular filter about an axis while a differential pressure is applied to an interior space of the tubular filter relative to exterior the tubular filter, and
a force is applied, related to the rotation of the tubular filter, to particulate matter agglomerated to an exterior surface of the tubular filter such that the particulate matter is removed from the exterior surface.

15. The apparatus of claim 13, wherein the tubular filter includes a plurality of vanes coupled to the exterior surface, and configured to guide the unfiltered fluid through the apertures.

16. The apparatus of claim 15, wherein entrances of the plurality of vanes are arranged in an orientation of a rotation of the tubular filter.

17. The apparatus of claim 15, wherein entrances of the plurality of vanes are arranged in an orientation opposite to a rotation of the tubular filter.

18. The apparatus of claim 13, wherein the tubular filter includes an impeller coupled to an inner surface of the tubular filter, wherein the impeller is configured to draw the unfiltered fluid through the apertures of the tubular filter from the interior space of the tubular filter as the tubular filter rotates.

19. The apparatus of claim 13, wherein the tubular filter has a circular cross section.

20. The apparatus of claim 13, wherein the tubular filter has a rectangular cross section.
